(19) United States
(12) Patent Application Publication
(10) Pub. No.: US 2017/0307794 A1
(43) Pub. Date: Oct. 26, 2017

(54) OPTICAL FILTER FOR IMPROVING VISUAL RESPONSE TO AMBER AND RED LED EMISSIONS

(71) Applicant: Hunter Bros. LLC, Highland, IL (US)

(72) Inventor: Marc W. Hunter, Highland, IL (US)

(21) Appl. No.: 15/507,948

(22) PCT Filed: Sep. 9, 2015
(86) PCT No.: PCT/US2015/049201

§ 371 Date: Mar. 1, 2017

Related U.S. Application Data
(60) Provisional application No. 62/047,708, filed on Sep. 9, 2014.

(51) Int. Cl. G02B 5/22; G02B 5/28; G02C 7/10

(52) U.S. Cl. CPC G02B 5/223; G02C 7/107; G02B 5/286; G02C 7/104

(57) ABSTRACT

An optical filter for eyewear and other viewing devices improves response to certain amber and red spectral emissions particularly from amber and red LEDs, without materially reducing appearance and discernment of pertinent items and signals present during driving activity, utilizes a narrow bandpass light filter in a “tuned” manner to pass portions of the visible spectrums of amber and red LED emissions to a high degree, while simultaneously reducing, but not effectively eliminating transmission of out-of-band spectral light. As a result, the amber and red LED emissions (signal) are selectively emphasized and out-of-band transmittance of background light (noise) are attenuated, thereby increasing the signal-to-noise ratio of the amber and red LED light sources found in traffic signals and vehicles. To a lesser degree, the same effect is achieved for filtered, amber and red incandescent sources as well.

This application is submitted under 35 U.S.C. 371 claiming priority to PCT/US2015/49201, filed Sep. 9, 2015, which application claims the benefit of U.S. Provisional Application No. 62/047,708, filed Sep. 9, 2014.

### TECHNICAL FIELD

The invention relates generally to an optical filter for eyewear and the like for improving response to certain amber and red spectral emissions particularly from amber and red LEDs, while still allowing sufficient transmission of the remaining pertinent light spectrum for safety and functionality while driving and other activities.

### BACKGROUND ART

PCT patent application Serial No. PCT/US2015/49201, filed Sep. 9, 2015, and U.S. Provisional Application No. 62/047,708, filed Sep. 9, 2014, are incorporated herein by reference in its entirety.

The act of safely driving a motor vehicle is a complex psychomotor task, heavily dependent on quick reaction to important visual inputs, making correct decisions and applying these decisions to vehicle control. One of the most critical driver responses is their reaction time during detection and then identification of key visual stimuli. Reducing reaction time directly reduces the time required for the overall driver/vehicle system response. In the real world, this reduced response time translates to shorter braking distances as well as improved decision-making and better vehicle control decisions. Each of these factors reduces accidents, injuries and fatalities.

Scientists have studied and documented the inverse relationship between visual signal intensity and reaction time for over a century. It is well understood that the more intense the visual signal or the greater the contrast of the visual signal, the faster the reaction time (down to some asymptotic level). In the real world application of this principle, it has been found that a person will react faster to a bright light than a dim light and faster to high contrast signals than low contrast. FIG. 1 is a representative illustration of the slowing of reaction time at lower signal luminance levels.

It is also well understood that the more light reaching the eye, the better is the person's acuity and contrast sensitivity. It has been found that documents that are not legible under low lighting can be made easily legible by increasing the ambient light level. A key is to have adequate scene adaptive luminance for the visual system to function at its best. FIG. 2 shows how acuity (and also contrast sensitivity) degrades at lower scene luminance, meaning signs are more difficult to read, dashboard information is less legible and fine scene details disappear. Maximizing the light reaching the eye is critical for optimal visual performance in that it leads to improved visual neural response. It also results in a smaller diameter pupil and thus reduced spherical aberration and better depth of focus.

Lighting and transportation researchers have studied the reaction time to traffic signals of varying luminance levels—levels that encompassed the luminance losses one might see with the wearing of traditional sunglasses. Reference in this regard, Bullough, J. D., Boyce, P. R., Bierman, A., Conway, K. M., Huang, K., O'Rourke, C. P., Hunter, C. M., and Nakata, A. (1999). Luminous intensity for traffic signals: A scientific basis for performance specifications. Lighting Research Center, Rennselaer Polytechnic Institute, Troy, N.Y.

The Bullough et al. findings are consistent with those of previous research that was less specific in that it dealt with more generic light sources. Bullough et al found that transmittances typical of dark sunglasses (10%-20%) would yield increases in reaction time by 200-300 msec over a non-eyewear condition. For amber and yellow LED sources, wearing traditional sunglasses would increase reaction times by 25%-40% over the non-eyewear condition. A vehicle moving at 70 mph would travel approximately another 20-30 ft in the 200-300 msec longer reaction time. The implication of an additional 20-30 ft for vehicular control, collisions, injuries and fatalities is a matter of concern and is desired to be reduced.

The amber (yellow) and red light spectral ranges are important in the context of driving, as they are universally used to convey important information to drivers (i.e., caution, turning, and stop). It would be advantageous to improve driver detection and identification of these amber and red signals, and reaction times to these signals, to improve driver performance and safety. Manufacturers of vehicles (autos, trucks, motorcycles, etc) and traffic signals (intersection traffic control and warning lighting) have, in recent years, embraced the use of Light Emitting Diodes, referred to as LEDs, in their products and it is expected that the use of LED technology will continue to grow in the future. It has been found that LED sources typically emit across a more limited band of the visible spectrum for the particular color of the LED, compared to common spectrally-filtered incandescent bulbs. Thus, amber LED emissions have an identifiable bandwidth or spectral range, and red emissions have one also. It thus would be desirable to develop a manner of improving the prominence and recognition of, and reaction to, the amber and yellow spectral ranges of LED signal emissions, for eyewear for driving and other applications.

It is known to filter bands of light for various purposes. Reference U.S. Pat. No. 4,952,046, issued Aug. 28, 1990 directed to an optical lenses with selective transmissivity functions. Reference also, U.S. Pat. No. 5,400,175, issued Mar. 21, 1995, directed to an ultraviolet radiation and blue blocking polarizing lens. These patents have focused on development of “blue-blocking” filters for eyewear, where ultraviolet and short wavelength blue spectra are absorbed or reflected to both protect the eye from UV damage as well as to reduce the perception of atmospheric and intraocular scatter. Reference also, U.S. Pat. No. 5,170,501, issued Dec. 15, 1992, directed to a welding mask to prevent orange flare and method of welding. Still further, reference U.S. Pat. No. 6,132,044, issued Oct. 17, 2000, directed to a filter for a special purpose lens and method of making an optical filter, particularly for filtering and analysis techniques to optimize or enhance the appearance of shades within a single color (i.e., to obtain more information from a golf putting green); and U.S. Pat. No. 6,893,127, issued May 17, 2005, directed to activity-specific optical filters and eyewear using such filters; and U.S. Pat. No. 5,592,245, issued Jan. 7, 1997, directed to an apparatus for enhancing visual perception of selected objects in recreational and sporting activities, such as between tennis or golf balls (and other sport-related objects) and their typical natural backgrounds; and also U.S. Pat. No. 8,770,749, issued Jul. 8, 2014, directed to eyewear transmittance designs that are aimed at improving the chromatic information transmitted in environments such as road and trail bicycle riding, shooting, water sports, snow sports, golf and baseball, using narrow band absorptive organic dyes.

While the above referenced patents indicate a wide scope of knowledge in the optical filter art, the known filters fail to address the specific conditions present in driving applications, particularly the need to maintain high visibility and discernment of, and reaction to, both important signals, e.g., amber and red, as well as other objects in the field of vision, namely, other vehicles, pedestrians and other hazards, signage, other signals, including green lights, etc, all under a wide variety of environmental/ambient lighting conditions, i.e., varying degrees of sunlight, sun angle, cloud cover, rain, fog, mist, snow, glare, headlights, commercial signage, and other direct and reflected or indirect light “noise” or interference, which conditions can be variously changing.

It must also be considered that a driver may be viewing the light environment including the amber and red signals, through various intended filters or other transmission limiters such as a tinted window or windows, which may be different, i.e., different degrees and/or colors of tint or shading, including over the individual surfaces thereof, such as commonly utilized on vehicle windshields and windows. The driver's view may also be obscured by rain, dust, grime, pollutants, scratches, degradations, imperfections, aberrations, etc., on or in the window or windshield, or the driver may be looking in one direction through a covered window, then in another direction through an open or different window with different or no transmission limiters, so that his or her eyes may be adjusting to the different conditions.

The environmental lighting conditions may also be changing, such as when driving in and out of shade, such as when moving through a partial or intermittent canopy of trees, or when background changes, moving between buildings, in and out of traffic, across intersections, etc. The amber and red signal lights may also not be significantly brighter or more prominent, or may be more distant, and/or dimmer, than other light sources, including daytime running lights, headlights, and the like, that may be present.

Thus, what is sought is a manner of filtering environmental light conditions, to improve appearance and recognition of, and response to, amber and red signals, particularly amber and red LED emissions, without materially reducing appearance and discernment of, and reaction to, other pertinent items and signals present during the driving activity.

### SUMMARY OF THE INVENTION

What is sought is a manner of filtering ambient light conditions, to improve appearance and recognition of, and reaction to, amber and red signals, particularly emitted by amber and red LEDs, without materially reducing appearance and discernment of pertinent items and signals present during the driving activity.

According to a preferred aspect of the invention, a thin-film bandpass light filter is utilized in a “tuned” manner to pass portions of the visible spectrums of amber and red LED emissions to a high degree, while simultaneously reducing, but not effectively eliminating transmission of out-of-band spectral light. As a result, the amber and red LED emissions (signal) are selectively emphasized and out-of-band transmittance of background light (noise) are attenuated, thereby increasing the signal-to-noise ratio of the amber and red LED light sources found in traffic signals and vehicles. To a lesser degree, the same effect is achieved for filtered, amber and red incandescent sources as well.

According to another preferred aspect of the invention, the optical media substrate into or onto which the invention is incorporated, can consist of any number of materials including but not limited to visually transparent, or substantially clear, glass, plastics, and polycarbonate, such as, but not limited to, high grade visually clear plastics or polycarbonate such as used in a variety of eyewear products commercially available for driving, sports, sun and eye protection.

As non-limiting preferred manners of manufacture, vacuum deposited thin-film coatings, both broad band and narrow band absorptive dyes, polarizer and other technologies can be applied separately and/or in combination to a substrate to yield the desired optical characteristics, that is, to transmit the desired spectral range of the amber and red LED signals to the extent sought, while attenuating the spectral energy that falls outside the selected spectral range emitted by these LEDs to an effective extent, that is, to still allow adequate and effective detecting appearance and discernment of, and response to, pertinent items and signals present during the driving activity.

In regard to the latter point above, it should be understood that while nearly complete visual attenuation of all extraneous spectral sources is possible, this would not be safe or practical, as the driver must still drive the vehicle and navigate under the various conditions referenced above, namely ambient daytime lighting conditions, including sometimes while viewing through filtered media, window tinting, shading, including when covered with dirt, grime rain, etc., and which conditions can be changing. This necessitates that sufficient “out-of-band” spectral energy be transmitted by the optical media to ensure the driver can see and react to other vehicles, pedestrians, and other hazards, read road signs, judge relative speed, read key instruments within the vehicle including when not illuminated, navigate, and react or not react to other external stimuli.

According to another preferred aspect of the invention, it is contemplated that the present invention would have its greatest utility under daylight conditions, including in and near dawn and dusk times, when at least some indirect sunlight is present. It is recognized that driver reaction time is sensitive to attention demands, distractions, driver fatigue, atmospheric and weather conditions, luminance contrast, perceived contrast, color contrast, absolute luminance and perceived luminance (or brightness), and the bandwidth selected for the filter of the invention has been found to improve reaction time under these conditions, with an objective to improve safety and reduce vehicular accidents, injuries and fatalities.

The improvement in terms of “driver mindset” is not to be overlooked, and the invention can be configured with an objective to increase the driver's concentration and confidence to make critical traffic and vehicle signals and vehicle lighting more visible and less likely to blend-in with the background environmental “visual noise”. In particular, the filter of the invention has also been configured to provide better photopic transmission than a representative dark sunglass used as a baseline, for better visual acuity and contrast sensitivity, which has been found to provide improved sign legibility and detection/identification of fine scene details.

According to still another aspect of the invention, the filter is embodied in an optical coating that transmits a suitably determined range of amber and red LED spectra while simultaneously limiting the undesired out-of-band background spectra to acceptable levels. In testing, when the filter of the invention was compared to representative dark, neutral density sunglass eyewear, amber and red LEDs appear noticeably brighter, and background spectra was effectively reduced. Combined, these attributes have been found to yield striking contrast improvements over tested known neutral density and color-tinted sunglass eyewear.

According to yet another preferred aspect of the invention, further improvements in contrast and visibility of the amber and red LED spectral ranges can be made by including an absorptive dye to the substrate material that also serves to limit background spectra. These desired optical properties can be applied to all manner of eyewear. Particularly, the absorptive dye or dyes selected would only minimally reduce transmission of amber and red LED transmissions, while noticeably limiting transmission of other light ranges to a desired extent.

According to still another preferred aspect of the invention, for eyewear product application, the filter and thus driver performance do not rely on optical substrate material or frame shape or curvature. Any product that requires the user to view his environment through a transparent optical media can be considered a potential medium for application of the invention. Examples in addition to eyewear include, but are not limited to: a) visors that would typically be used in helmet applications for motorsports and motorcycle applications; b) goggles that would be strapped to the wearer's head; c) media attached to the windshield as an aftermarket-supplied component; and d) an extendable optical component that can be attached or is integral to the sun visor, used during daytime conditions.

Application categories include, but are not limited to: automotive, commercial truck, motorcycle, bicycle, scooter/moped, racing application including all forms of oval racing, road racing and drag racing. In addition, the filter of the invention can be incorporated into sunglass eyewear, and other eyewear that can be worn in conditions other than driving or racing applications.

### BRIEF DESCRIPTION OF THE DRAWINGS

FIG. 1 shows the inverse relationship between visual signal intensity (luminance) and reaction time. Reaction time decreases as signal intensity grows, up to some asymptotic value where reaction time can no longer improve.

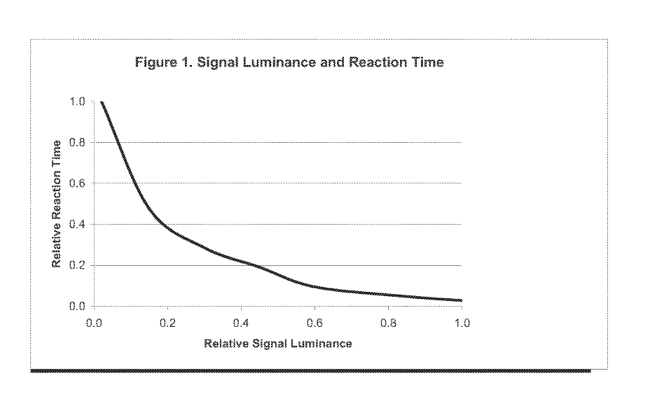

FIG. 2 shows the relationship between visual acuity and visual adaptive luminance. Visual acuity improves with higher visual adapting luminance due to improved neural processing and reduced pupil diameter, which eliminates sources of spherical aberration.

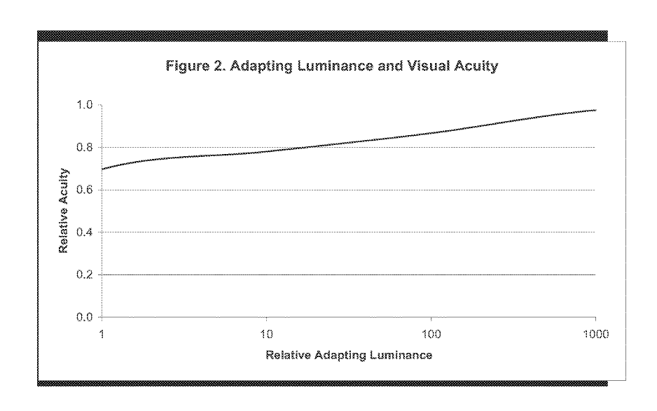

FIG. 3 compares broadband incandescent traffic signal spectral emissions with those of LEDs for amber and red signals.

FIG. 4. Embodiment of the current invention. Narrow bandpass filter in the amber-red region that allows nearly 90% peak transmittance and lower transmittance out-of-band.

FIG. 5. Comparison of typical gray and color tinted sunglass spectral transmittance compared to embodiment of the current invention.

FIG. 6. Photopic sensitivity function, current invention embodiment and the photopic weighted embodiment of the current invention. Photopic transmittance of the invention embodiment is about 35%.

FIG. 7. Embodiment of the current invention and amber and red LED emissions. Note invention bandpass has been tuned to transmit nearly all of the LED emissions, but greatly reduce out-of-band transmission.

FIG. 8. Possible configurations of substrate, selective spectral filter(s) and anti-reflection coating(s).

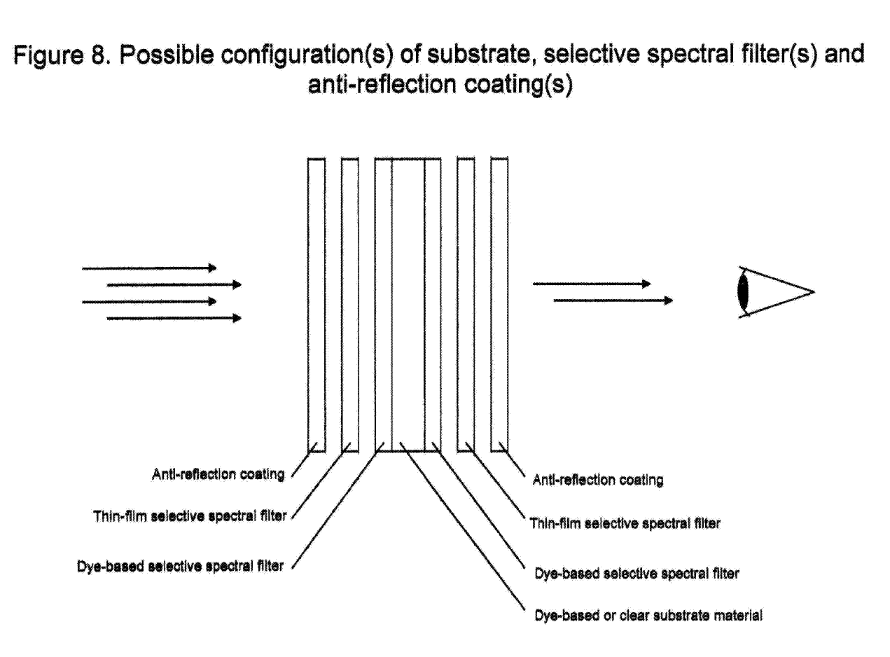

FIG. 9. Visual signals, selective spectral filtering and the driver.

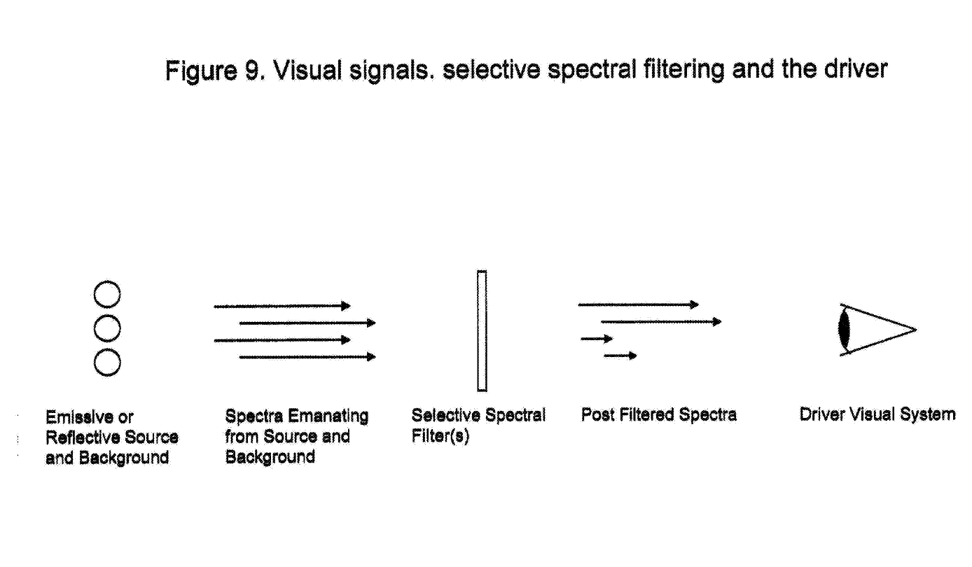

### DETAILED DESCRIPTION OF THE INVENTION

To improve driver visual performance in the context of the invention requires some manner of combining: a) higher LED signal luminance; b) higher LED signal contrast; and c) higher overall scene adapting luminance. It has been found that these three factors combine to yield important benefits, particularly, faster reaction times, improved target visibility, improved visual acuity and contrast sensitivity, and improved legibility. So for optimal driver performance, it is concluded that what is required is to allow as much light as possible to reach the eye and to improve contrast (and thus visibility) of key information, all while providing adequate relief from glare sources that could degrade visibility and comfort.

Currently, eyewear worn by drivers during higher ambient illuminance conditions typically consist of sunglasses that have dark, neutral density or tinted lenses and are not optimized to the driving task. Regardless of their “color” (gray, green, amber, yellow, rose, etc), these lenses have been found to all be essentially the same in terms of their impact on driver performance. While they may reduce glare by cutting down on the amount of light reaching the eye, they do so at a cost. As a representative example, it has been found that broadband transmittance of sunglasses is typically about 10%-30%, meaning that both background (noise) and lighting (signal) are reduced in luminance by up to 90% and there is no improvement in contrast of that signal or any of the other visual information other than the reduction in veiling glare caused by intraocular scatter or specular veiling glare reduced through the use of polarizing materials. A US standard for sunglass eyewear is ANSI Z80.3 and it defines minimum spectral transmission requirements. Similar such standards exist in countries worldwide.

Broadband absorptive filter technology is used in most sunglass and fashion eyewear due to the relatively low technology production costs. Absorptive dyes are well understood by the eyewear and filter industries and have been used successfully for decades to both reduce overall transmittance for sunglasses as well as to provide spectral tints for both the sunglass and fashion eyewear markets. In production, absorptive dye(s) are applied directly to the substrate material to achieve the desired spectral transmittance—anti-reflection coatings and metallic reflective coatings can be added later in the process. However, the broadband absorptive nature of the dyes has been found to limit the technology, as it is unable achieve the very narrow spectral transmission bands of thin-film coatings.

As noted above under the Background Art heading, LED traffic signals and the use of LED lighting will only continue to grow. The LED spectral characteristics and their adoption by the vehicle and traffic signal industries provides a unique opportunity to develop spectrally selective eyewear that can dramatically improve driver visual performance (and thus safety) when compared to traditional sunglass eyewear or the case where the driver wears no eyewear at all.

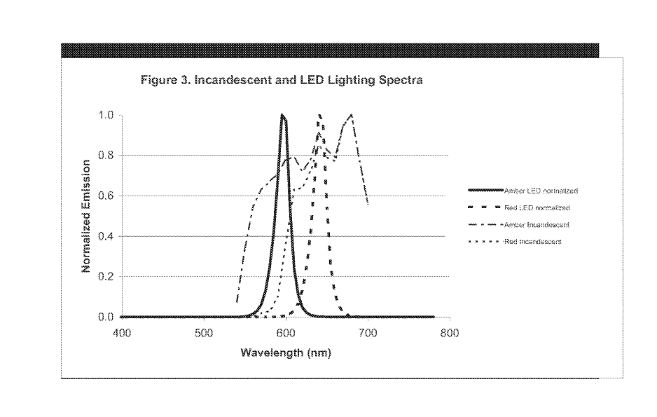

A spectral emission comparison of the red and amber-filtered incandescent traffic signals with red and amber LED is shown in FIG. 3. Of primary importance is the broadband emissions produced by the incandescent sources and the comparatively narrow band emissions of the LED sources.

According to the invention, a suitable thin film coating is used to accentuate the visibility of the narrow band LED vehicle and traffic signal emissions, while reducing the visibility of other, more broadband spectral information. The results have been found to include: a) higher photopic transmittance; b) higher LED transmittance; c) higher LED and incandescent signal contrast; and d) minimal chromatic shift to the overall scene. The impact on driver performance is better signal visibility and reduced reaction time.

### Selective Filtering for Better Performance.

The typical 3-light traffic signal is comprised of green, amber, and red lights. However, the key lights from a reaction and safety viewpoint for the purposes of the invention are the amber (caution) and red (stop) signals. These amber and red lights, until just recently, were primarily incandescent technology that is relatively broadband in its emission across the visible spectrum (380-760 nm). Similar broadband light sources have been used in the amber (turn signal) and red (braking) lighting applied to street driven vehicles, but are now being replaced by narrower spectral emission LED lighting. Manufacturers of traffic lighting signals and automotive vehicles are now dictating the use of LED technology as it has been found to be more rugged, brighter, higher in contrast and has shorter rise (turn-on) times. LEDs are electroluminescent devices whose emission spectra is dictated by the material used within the photodiode, and at times somewhat by the outer lens spectral qualities. The emission spectra of typical amber and red LEDs are narrow-band, more similar in nature to a laser than a broadband source.

In the U.S., the U.S. Department of Transportation (US DOT) sets lighting intensity and spectral quality standards through the Institute of Transportation Engineers (ITE). There are an estimated 300,000 intersections in U.S. alone, with over 1 million individual traffic lights. Also here in the U.S., the National Highway Transportation and Safety Association (NHTSA) sets standards for vehicle lighting. Nations worldwide have their own standards organizations, but a commonality among them is that LED technology is replacing existing traffic signals and vehicle lighting due to its superior performance, low-cost and long life. Narrow band driving eyewear specifications may need to be slightly modified in other markets around the world, due to minor differences in national lighting standards, but it is also possible that a single eyewear coating design may be acceptable for all countries of interest.

Selective spectral filtering, however, has been found to be capable of reducing the intensity of background information, and still pass the vast majority of signal luminance, thus increasing contrast of the key visual information as well as allowing higher adaptive luminance levels. Again, achieving these goals reduces driver reaction time as well as improves acuity and contrast sensitivity. Such a selective filtering approach can enhance driver performance over conditions where they are wearing no eyewear or conditions where they are wearing typical dark neutral or tinted sunglasses.

Selective spectral filtering provides the opportunity for high signal transmittance, improved signal contrast, better signal visibility and higher overall broadband photopic transmittance, and can do so while providing a more neutral chromatic scene. Because selective spectral filtering manipulates narrow bandwidths, it minimizes the chromatic shift in the driver's real world appearance.

### Narrow Bandpass Filtering

Narrow bandpass filtering has been found capable of providing a number of benefits, including, but not limited to: a) tight control of spectral transmittance so that there is minimal degradation of key visual information; b) tight control over out-of-band information; and c) minimal chromatic shift of the “real world”. One preferred manner of achieving this narrow bandpass filtering according to invention is to use dielectric thin-film coatings that are comprised of multiple layers of thin metals each having a different index of refraction, that are deposited in a vacuum chamber onto the optical substrate. It has been found through research and experimentation, that materials making up a coating stack, their indices of refraction, as well as the number of layers of the stack, are variables that can be adjusted to achieve the precise spectral reflectance (transmission) characteristics required to achieve the visual performance desired for the invention.

For a variety of reasons, e.g., light-weight, low-cost, ease-of-manufacturing, known product acceptance, plastics and polycarbonates provide a preferred substrate for the coating stack of the invention, although the present invention is not to be limited to plastics and polycarbonate substrates only, and can include glass also. However, applying the coating stack of the invention to plastic substrates has been found to be technically challenging. Many of the commercial suppliers of thin-film coatings suitable for eyewear have been: a) unable to achieve the tight spectral tolerances desired; b) unable to apply their coatings to plastic substrates; and/or c) able to approach the spectral tolerances required by the invention, but could not consistently replicate the coating specified. One thin-film supplier that has successfully produced the desired stack coating meeting the requirements of the invention is Evaporated Coatings, Inc., of Willow Grove, Pa. USA.

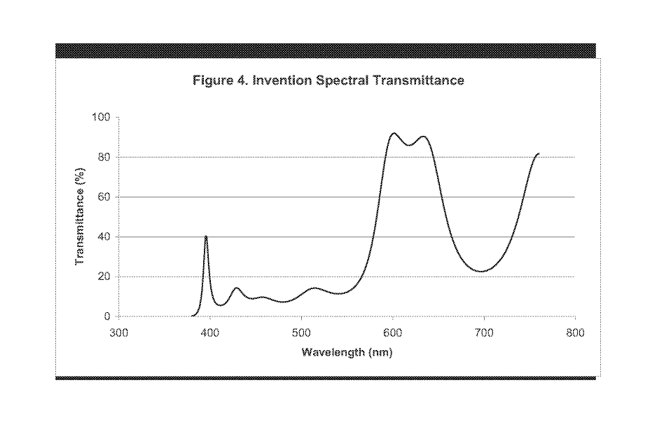

FIG. 4 shows a representative embodiment of the coating stack of the invention, applied on a polycarbonate optical substrate (substrate material can be glass, plastic, polycarbonate—any optically clear media) as a single bandpass filter to encompass the sought after portions of the spectra of both the amber and red LED vehicular and traffic signal light sources. It is also contemplated that a multiple bandpass thin film coating design could be applied according to the invention, for instance a two bandpass configuration having one bandpass for the amber LED emission spectra and another for the red LED emission spectra.

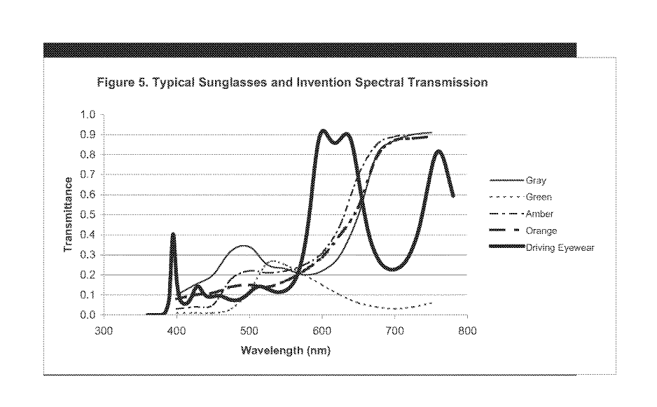

Comparison of a representative embodiment of the selective bandpass thin film filter of the invention, with examples of neutral (gray) and tinted (green, amber, orange) sunglass, yields spectral transmittances as shown in FIG. 5. Of primary interest is the general, broad band shape of the spectral transmittance for the neutral and tinted sunglasses, not the absolute transmittance values as these can be easily modified by the manufacturer to suit their needs. Notable is the tightly defined spectral bandpass of the thin film filter, compared to the dye-based sunglass eyewear. Also, the very high in-band transmittance (about 80%-90%) should be noted and the tightly controlled out-of-band transmittance (about 10%-15% in the primary visible region) for the invention. The high in-band transmittance provides high amber and red LED intensities, while the controlled out-of-band (nearly flat) transmittance creates a more neutral chromatic appearance. Contributing to this more neutral appearance is the tight “notch” of the bandpass filter—designed to match the desired ranges of amber and red LED emissions, while disrupting as little of the other chromatic information that reaches the eye as is practical.

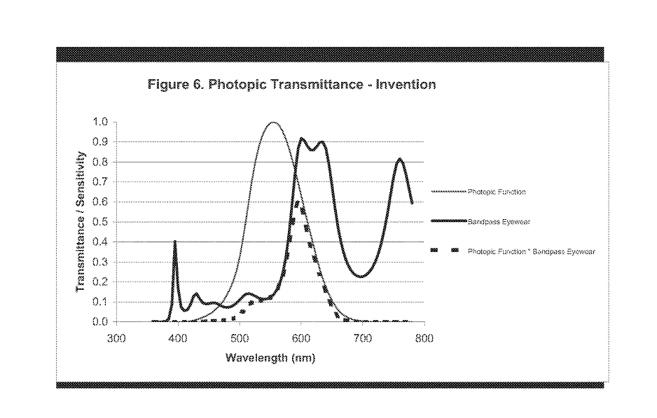

FIG. 6 shows an embodiment of the invention, the photopic sensitivity function, and the embodiment of the invention weighted by the photopic sensitivity function. This photopic function illustrates the spectral sensitivity of the average human eye when operating at relatively high light levels (i.e., those where color vision is still active). It is used in this instance to illustrate the degree of sensitivity to those wavelengths being manipulated by the selective thin-film filter. The embodiment shown in FIG. 6 has been found to yield approximately 35% photopic transmittance. For reference, the traditional gray and color-tinted sunglasses illustrated in FIG. 5 may yield about 10% to about 20% photopic transmittance in many cases. ANSI/Z80.3 defines minimum transmittances in the US—other countries have their own, similar standards organizations in place.

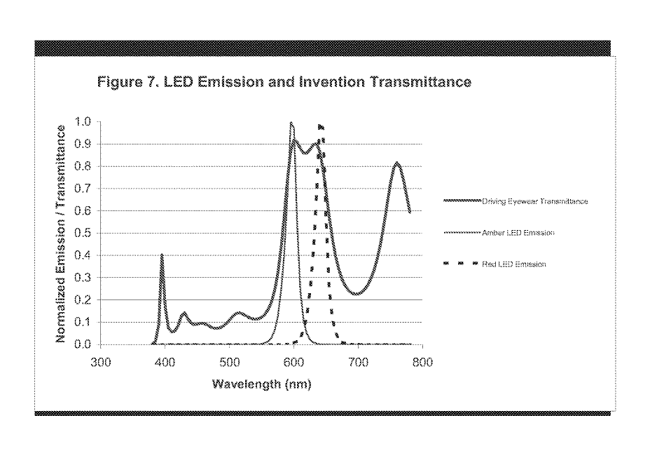

FIG. 7 clearly illustrates how amber and red LED spectral emissions fall within the preferred embodiment of the invention. Again, the design could employ multiple bandpass filters, each tuned to the specific emission spectra of the LED lighting of interest. The illustrated coating embodiment passes nearly 90% of the LED emissions, but also limits out-of-band visible emissions (about 380 to about 550 nm and about 680 to about 760 nm) to much lower levels. In this case, the out-of-band levels were selected to maximize LED contrast and yet still provide transmissions that were typical of current sunglass eyewear and that meet ANSI Z80.3 requirements. These in-band and out-of-band spectral transmittances can be tuned according to the invention to meet the needs of the eyewear manufacturer and their consumer base. In this case, the design maximizes red and amber LED transmittance and contrast, while providing about 35% (higher than typical sunglasses) photopic transmittance (and thus adapting luminance and acuity) and provides minimal disruption to the chromatic appearance of the “real world”.

It is recognized within the scope of the invention that hybrid eyewear designs that combine broadband absorptive dye(s) with thin-film bandpass filters or designs consisting only of narrow band absorptive dye(s) and/or anti-reflection coatings provides the eyewear industry with a broad range of high quality consumer options. In terms of the driver safety goals of the invention, it is recognized that combining amber and red thin-film bandpass filters with a broadband absorptive dye (having higher transmittance in the amber-to-red region) would yield eyewear with lower overall photopic transmittance (similar to a typical sunglass) but that would still provide significant improvement in the amber-red contrast and would still provide higher than typical broadband sunglass amber-red transmittance. This hybrid design, however, represents a compromised solution in terms of reaction time improvement and overall transmittance when compared to the more focused amber-red thin-film bandpass filter design, and thus while still within the contemplated scope of the invention, would not be the preferred embodiment of the invention. Further, a design consisting only of narrowband dye(s) represents another compromised solution, and while still within the contemplated scope of the invention, would be a less preferred embodiment of the invention.

Given the current emphasis and level of attention being paid to “driver distraction” due to the more frequent use of electronic communications (i.e., smart phones) such as audio phone calls, texting, electronic maps, and online surfing, it is perhaps more important than ever to shorten driver reaction time. Driver distraction is an issue and while improving signal luminance and contrast through narrowband spectral filtering will have no direct impact on driver distraction, a compelling argument can be made that the distracted driver needs all the help that can be provided to detect and react to key visual signals in the driving environment. While they may still be distracted, at least drivers may react more quickly once they have detected the signal.

In addition, the driver population is aging in many areas and the number of older drivers is only likely to increase as people live longer and are more healthy. It is known that older drivers will suffer degraded visual acuity and contrast sensitivity due to poorer photoreceptor function, neural function and reduced intraocular transmittance. Combined with generally slower reaction times of older drivers, it becomes increasingly important to do what can be done to provide them with a) reduced glare, b) higher adapting luminance, c) higher contrast, and d) improved visibility of key visual signals. Each of these goals can be achieved through incorporation of narrow band spectral filtering of the invention in their driving eyewear.

The following are some of the key visual signals that can be enhanced through the narrow band spectral filtering of the invention:
1. Amber, Red and Green lighting signals (intersections, school zones, construction zones, etc);
2. Amber and Red lighting on vehicles (taillamps, brake lamps, turn signals, etc);
3. Emergency vehicle flashing or strobe lighting;
4. Yellow reflective surfaces (yellow road lines, school buses, road signs, etc);
5. Orange reflective surfaces (road construction signs, construction equipment, etc);
6. Red reflective surfaces; and
7. Red/amber lighting worn by pedestrians and bicyclists.

By increasing the overall transmittance of the eyewear, the invention increases the adaptive luminance for the driver and thus improves visual acuity and contrast sensitivity—leading to their ability to read printed signs at greater viewing distances and allowing for more “decision time” and less time sensitive workload. Essentially, by passing more light to the eye, the invention provides an operating environment where drivers can see fine details better and more quickly as well as information that may be very low in contrast (and thus easy to miss).

The same arguments hold for other situations where the same visual signals are important, such as:
1. Bicyclists.
2. Motorcyclists.
3. Automotive and motorcycle racing applications such as oval, road course, off-road, and drag racing.

Selective filtering according to the invention provides a number of benefits to the driver.
1. Background colors or light that is not of critical importance can be attenuated.
2. Key colors such as red and amber LED can be passed with virtually no attenuation, while non-LED signals are also passed, but to a lesser extent.
3. Blocking the background or “visual noise” allows the driver to better detect, identify and focus on the “signal”.
4. Reducing noise and/or increasing signal are key to improving the visual signal/noise ratio.
5. As the S/N ratio increases, RT is shortened, leading to shorter braking distances, more time for vehicle control decisions and corrections.
6. Narrow bandpass coatings filter more efficiently, providing higher adapting luminance levels and thus, better acuity, sign legibility, and fine target detection and identification.
7. Shortened RT achieved through better signal visibility can make a significant difference in driver safety. Traveling 70 mph, a 200 millisecond (⅕ of a second) faster reaction means that the driver has reacted 20-30 feet quicker and thus completed their vehicular inputs 20-30 feet quicker.
8. Shorter RT that lead to shorter braking distance, better vehicle control and improved decision making reduces accidents as well as injuries and fatalities. Having an accident or avoiding one completely can come down to inches. Having a minor accident with no injuries or having minor injuries can come down to a few feet. Having minor injuries or incurring life-threatening or fatal injuries can come down to only a few more feet.

In light of all the foregoing, it should thus be apparent to those skilled in the art that there has been shown and described an OPTICAL FILTER FOR IMPROVING VISUAL RESPONSE TO AMBER AND RED LED EMISSIONS. However, it should also be apparent that, within the principles and scope of the invention, many changes are possible and contemplated, including in the details, materials, and arrangements of parts which have been described and illustrated to explain the nature of the invention. Thus, while the foregoing description and discussion addresses certain preferred embodiments or elements of the invention, it should further be understood that concepts of the invention, as based upon the foregoing description and discussion, may be readily incorporated into or employed in other embodiments and constructions without departing from the scope of the invention. Accordingly, the following claims are intended to protect the invention broadly as well as in the specific form shown, and all changes, modifications, variations, and other uses and applications which do not depart from the spirit and scope of the invention are deemed to be covered by the invention, which is limited only by the claims which follow.

What is claimed is:

1. A viewing device to be placed in a wearer's optical path to increase visual contrast of certain emissive and reflective signals within a visual spectra of between about 380 nm and about 760 nm transmitted through the viewing device to increase visibility of the signals relative to other visual information, comprising:
a substrate substantially transparent to the visual spectra; and
at least one selective spectral filter applied to the substrate, comprising a dye-based filter, a thin-film coating, or a combination of a dye-based filter and a thin-film coating, configured to transmit a substantial portion of the visual spectra within a narrow band of between about 585 nm and about 650 nm and to substantially limit transmission of the visual spectra beyond the narrow band.

2. The viewing device of claim 1, wherein the spectral filter is configured to limit the transmission of the visible spectra beyond the narrow band by to between about 10% to about 15%.

3. The viewing device of claim 1, wherein the thin film coating of the at least one selective spectral filter comprises multiple layers of thin metals each having a different index of refraction.

4. The viewing device of claim 1, wherein the at least one selective spectral filter is configured to transmit at least about 80 percent of the visual spectra within the narrow band of between about 585 nm and about 650 nm.

5. The viewing device of claim 1, wherein the at least one selective spectral filter is configured to encompass up to about 35 percent of a bandwidth of the visual spectra encompassed by a known photopic function of an average human eye.

6. The viewing device of claim 5, wherein the spectral filter is configured to transmit no more than about 65 percent of emissions at any wavelength within the visual spectra encompassed by both the narrow band of the spectral filter and the photopic function.

7. The viewing device of claim 5, wherein the spectral filter is configured to limit transmission of the visible spectra within a smaller wavelength region of the visible spectra encompassed by the photopic function to between about 10 and about 15 percent.

8. The viewing device of claim 5, wherein the spectral filter limits transmission of the visible spectra within about a lower one half of the bandwidth encompassed by the photopic function to between about 10 and 15 percent.

9. The viewing device of claim 1, wherein the spectral filter comprises at least one narrow band dye-based filter.

10. The viewing device of claim 1, spectral filter is constructed to transmit at least about 80 percent of emissions of amber and red LEDs.

11. The viewing device of claim 1, wherein the spectral filter comprises at least one broad band dye-based filter.

12. The viewing device of claim 1, wherein the spectral filter comprises at least one narrow band dye-based filter, at least one broad band dye-based filter, and at least one thin-film coating.

13. A viewing device to be placed in a wearer's optical path to enhance response to emissions of amber and red LEDs, comprising:
a substrate substantially transparent to a visual spectra of between about 380 nm and 760 nm; and
at least one selective spectral filter applied to the substrate, comprising a dye-based filter, a thin-film coating, or a combination of a dye-based filter and a thin-film coating, configured to transmit at least about 80 percent of the visual spectra within a band of between about 585 nm and about 650 nm and to reduce transmission of the visual spectra outside of the narrow band by between about 85 and about 90 percent.

14. The viewing device of claim 13, wherein the thin film coating of the at least one selective spectral filter comprises multiple layers of thin metals each having a different index of refraction.

15. The viewing device of claim 13, wherein the at least one selective spectral filter is configured to transmit up to about 35 percent of a bandwidth of the visual spectra encompassed by a known photopic function of an average human eye.

16. The viewing device of claim 15, wherein the spectral filter is configured to transmit no more than about 65 percent of emissions at any wavelength within the visual spectra encompassed by both the narrow band of the spectral filter and the photopic function.

17. The viewing device of claim 15, wherein the spectral filter is configured to limit transmission of the visible spectra within a smaller wavelength region of the visible spectra encompassed by the photopic function to between about 10 and about 15 percent.

18. The viewing device of claim 15, wherein the bandwidth of the visible spectra encompassed by the photopic function comprises a band of between about 450 nm and about 650 nm within the visible spectra.

19. The viewing device of claim 15, wherein the spectral filter limits transmission of the visible spectra within about a lower one half of the bandwidth encompassed by the photopic function to between about 10 and 15 percent.

20. The viewing device of claim 13, wherein the spectral filter comprises at least one narrow band dye-based filter.

21. The viewing device of claim 13, wherein the at least one selective spectral filter comprises at least one stack of thin-film coatings applied to the substrate.

22. The viewing device of claim 13 wherein the spectral filter comprises a plurality of narrow band dyes.

23. The viewing device of claim 13, wherein the spectral filter comprises at least one broad band dye-based filter.

24. The viewing device of claim 13, wherein the spectral filter comprises at least one narrow band dye-based filter, at least one broad band dye-based filter, and at least one thin-film coating.
